(19) United States
(12) Patent Application Publication
(10) Pub. No.: US 2003/0226015 A1
(43) Pub. Date: Dec. 4, 2003

(54) Method and apparatus for configuring security options in a computer system

(76) Inventors: E. David Neufeld, Magnolia, TX (US); Gina Donaldson, Houston, TX (US)

Correspondence Address: Fletcher, Yoder & Van Someren, P.O. Box 692289, Houston, TX, 77269-2289, US

(21) Appl. No.: 10/159,683

(22) Filed: May 31, 2002

(51) Int. Cl. H04L 9/00

(52) U.S. Cl. 713/166

(57) ABSTRACT

A security system includes different authentication levels and/or different privileges based on certain criteria. For example, if a user's identity can be somewhat assured due to the directness of the connection, authentication may be less rigorous than in a situation where the connection is more remote, thus making the user's identity less assured. Also, a user's privileges may be restricted if the user accesses the system from a remote location or during non-business hours.

### BACKGROUND OF THE INVENTION

1. Field of the Invention

This invention relates generally to computer security systems and, more particularly, to a technique for providing user profiles.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing the gigahertz (one billion operations per second) and continuing well beyond.

Productivity has also increased tremendously because of the explosion in development of software applications. In the early days of the PC, people who could write their own programs were practically the only ones who could make productive use of their computers. Today, there are thousands and thousands of software applications ranging from games to word processors and from voice recognition to web browsers.

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is the sheer scope of modern computer networks. At one end of the spectrum, a small business or home network may include a few client computers connected to a common server, which may provide a shared printer and/or a shared internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”), and municipal area networks (“MANs”). Clients may also have the ability to access these networks via a virtual private network (“VPN”) or via the Internet.

An important aspect of efficiently managing a large computer network is to maximize the amount of analysis and repair that can be performed remotely (for example, from a centralized administration site). Tools that facilitate remotely analyzing and servicing server problems help to control network management costs by reducing the number of network management personnel required to maintain a network in good working order. Remote server management also makes network management more efficient by reducing the delay and expense of analyzing and repairing network problems. Using remote management tools, a member of the network management team may identify problems and, in some cases, solve those problems without the delay and expense that accompanies an on-site service call to a distant location.

Remote management tools can communicate with a managed server using either (I) in-band communication or (2) out-of-band communication. In-band communication refers to communicating with the server over a standard network connection, such as the managed server's normal Ethernet connection. In-band communication with the server is, accordingly, only possible when the server is able to communicate over its normal network connection. Practically speaking, this limitation restricts in-band communication to times when the OS of the managed server is operational (online).

Out-of-band communication, which is not performed across the managed server's normal connection to the network, is a much more powerful tool for server management. In out-of-band communication, a “back door” communication channel is established by a remote server management tool (such as a remote console or terminal emulator) using some other interface with the server (such as (1) through the server's modem, (2) via a direct connection to a serial port, (3) through an infrared communication port, or (4) through an Ethernet interface or the Internet).

In a sense, out-of-band communication is like opening an unobtrusive window through which the inner workings of the operation of the managed server may be observed. After the out-of-band communication link with the server is established, the remote server management tool communicates with the server to obtain data that will be useful to analyze a problem or potential problem. After a problem has been analyzed, out-of-band communication may be possible to control the managed server to overcome the problem or potential problem.

In addition to the distinction between in-band and out-of-band communication with a managed server, another important distinction is whether the managed server is online or offline. The term “online” refers to a managed server in which the OS is up and running. The managed server is said to be “offline” if its OS is not up and running. Communications with a managed server may take place in one of these four states: (1) in-band online; (2) in-band offline; (3) out-of-band online; and (4) out-of-band offline.

An important goal in the development of remote server management tools is to increase the number of server problems that may be analyzed and repaired remotely (that is, without requiring direct, on-site intervention by a member of the network management team). To facilitate that goal, it is highly desirable to have a network management tool that is able to capture the maximum amount of information from a managed server in the maximum range of operational states of the server (for example, (1) in-band online; (2) in-band offline; (3) out-of-band online; and (4) out-of-band offline) and to allow control of the managed server based on that data.

Current remote management solutions combine the advantages of deep information gathering capability (software agent-based information gathering technology available when the OS of the managed server is online) with the ability to control the operation of the managed server independently via an out-of-band communication session using the dedicated server management computer system hosted in the managed server. Such remote management tools may also include the capability to capture video data and reset sequences from the managed server for remote display or replay at a later time. The capture of video data is facilitated by the close integration of a remote management tool with the managed server and the ability of the remote management tool to communicate with the managed server over existing communication links (such as an industry standard PCI bus). The ability of a remote management tool to capture video data from a managed server is a particularly powerful analysis tool because it lets a remote user have “virtual access” to the managed server, just as if the user was physically present and inspecting the managed server in person.

In a typical remote management system, a user (typically, a member of the network management team) can initiate an out-of-band session with the dedicated server management computer hosted in the managed server via a remote console application program being executed on a client computer. The management computer could be addressed by the user to control various aspects of the operation of the managed server via control circuitry connected to the embedded server management computer hosted by the managed server.

Regardless of whether the remote computer is communicating with the server to manage it or to carry out some other function, such as web serving, file sharing, device sharing, etc., security may be a very important issue. Indeed, computer security is becoming increasingly important in today's environment of heavily networked computer systems. As a result, security and integrity features are becoming desirable in the use of personal computers and servers. Providing security of a system involves protecting the system from a variety of possible attacks. Such security provisions may include protecting the system from accesses by hackers or other unauthorized entities. For example, for a specific business with proprietary internal systems and data, security systems may involve prevention of rouge or external devices from accessing the internal machines. Prevention of access by unauthorized external devices may be particularly problematic if the internal system is configured for remote access via a publicly accessible network, such as the Internet.

Remote access can be problematic, particularly when authentication and access control are required. Typically, remotely accessible devices, such as servers, have relied on locally defined lists of users and passwords to perform such authentication and access control. Unfortunately, network administrators must maintain these lists on multiple systems, and users often must keep track of separate accounts and passwords. Thus, this type of system is both time consuming and difficult to manage.

Certain techniques can significantly increase user convenience by replacing difficult-to-manage passwords with biometrics and/or smartcard technology. In regard to the latter, smartcards have long been proposed for holding digital certificates, private keys, and other means of proving one's identity. However, in the United States, they have not been widely deployed for various reasons. For example, companies have appeared reluctant to utilize smartcard technology due to the expense of retrofitting existing computers with smartcard readers. However, once implemented, smartcards require that users need only swipe the smartcard and type in a personal identification number to provide appropriate authentication.

Even with the use of passwords, personal identification numbers, and smartcards, a system is still only able to authenticate a computer and not a person because anyone who can guess or steal a user's password, personal identification number, and/or smartcard can digitally sign electronic documents and access data in that user's name. The formerly mentioned biometrics technology can be employed to solve some of these problems. In biometrics, a unique personal feature of each user, such as a retinal or fingerprint image or a voice pattern, is stored instead of a password. Access to computer resources are granted using a fingerprint or retinal identification scheme in much the same way as in a password scheme. However, instead of supplying a password, the user places an eye in front of a retinal scanner or a finger on a fingerprint reader that scans the person's feature and compares it with the previously stored data. Barring a malfunction or bodily mutilation, an authorized user always has a “key” or “password,” and unauthorized users cannot easily come into possession of it. Thus, biometrics solves the problems of authorized users who may have forgotten their password, as well as unauthorized users that may have come into possession of the password. Unfortunately, like smartcard technology, companies have been reluctant to embrace biometrics due to the expense of retrofitting existing computers with biometric scanners.

Furthermore, regardless of the manner in which a particular user is identified, the privileges granted to an authenticated user are typically the same regardless of when, where, or how the user accesses the system. However, it is believed to be desirable to alter authentication services and possibly to restrict access rights and privileges in some instances to improve security. For example, if a network administrator logs onto the system from a physically secure location where the network administrator's identification can be determined for the network administrator even to access the facility, the amount of user authentication and the number of restrictions placed upon a user in such a location need not be as onerous as user authentication procedures and restrictions placed upon users attempting to access the server from locations outside of the physically secure facility. Similarly, if the network administrator is accessing the server from a remote terminal that is affiliated with the business yet located outside of the secure facility, user authentication and restrictions may not need to be as onerous during working hours, when the user's identification can be somewhat assured and the user's actions somewhat monitored, as opposed to non-working hours, when a hacker or intruder could have more easily gained access to the remote terminal. Finally, this situation is potentially even more problematic if the system administrator attempts to access the server from a remote terminal located outside of work, such as at home or while traveling. In this situation, the system administrator must typically use the Internet or a virtual private network to access the system. However, because such an access is attempted from a location not directly affiliated with the business, there can be no assurances of the actual identity of the user absent rigorous authentication. Even with rigorous user authentication, greater restrictions may be placed on the same user when accessing the system remotely as opposed to accessing the system at work or directly from a secure facility. Furthermore, in the case of remote operation, even if the identity of the user can be determined with absolute certainty, some operations may be inherently more problematic because the user is not physically close to the work group using the server and may not know about a problem the user causes while remotely accessing the server.

The present invention may be directed to certain issues discussed above.

### BRIEF DESCRIPTION OF THE DRAWINGS

The foregoing and other advantages of the invention will become apparent upon reading the following detailed description and upon reference to the drawings in which:

FIG. 1 is a connection diagram of a managed server and a remote management console according to one embodiment;

FIG. 2 is a block diagram of the managed server according to the embodiment of FIG. 1; and

FIG. 3 is a block diagram of the remote management controller of FIG. 2.

### DESCRIPTION OF SPECIFIC EMBODIMENTS

The following patents or patent applications are hereby incorporated by reference:

U.S. Pat. No. 5,898,861, entitled “Transparent Keyboard Hot Plug” by Theodore F. Emerson, Jeoff M. Krontz and Dayang Dai;

U.S. Pat. No. 5,790,895, entitled “Modem Sharing” by Theodore F. Emerson and Jeoff M. Krontz;

U.S. patent application Ser. No. 08/733,254, entitled “Video Eavesdropping and Reverse Assembly to Transmit Video Action to a Remote Console” by Theodore F. Emerson, Peter J. Michaels and Jeoff M. Krontz, filed Oct. 18, 1996; and

U.S. patent application Ser. No. 09/438,253, entitled “Operating System Independent Method and Apparatus for Graphical Remote Access” by Theodore F. Emerson and Wesley Ellinger, filed Nov. 12, 1999.

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Indeed, an actual implementation of certain subject matter set forth herein may be found in Model DL360G2 available from Compaq Computer Corporation.

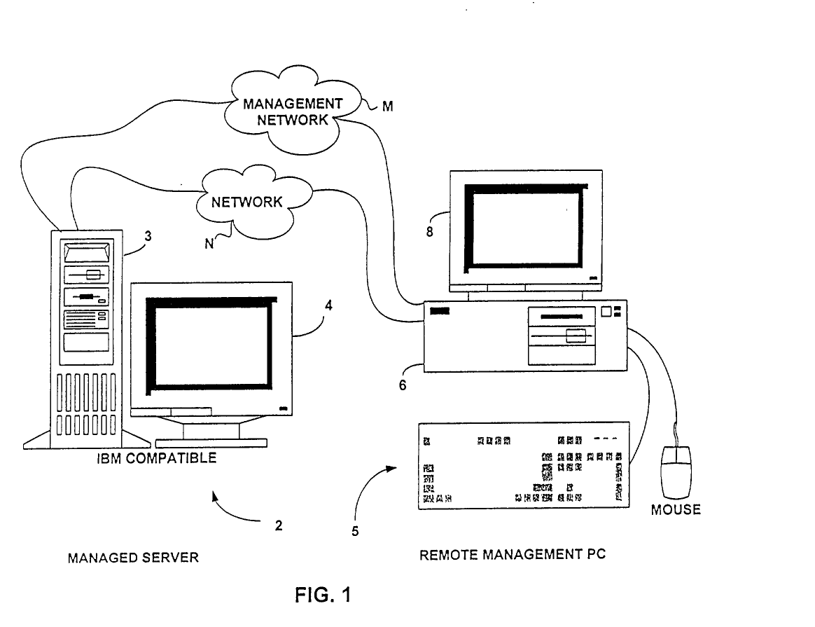

Referring first to FIG. 1, there is illustrated a managed server 2 connected to a remote console 5 by a network N. The managed server 2 includes a central processing unit (“CPU”) 3 housing processing, memory, communications, interface, and other circuitry as described more fully below, and may be connected to a monitor 4. The remote console 5 also includes a CPU 6 and a monitor 8. The managed server 2 includes special circuitry and software for capturing, analyzing, compressing and transmitting video activity to the remote console 5 independent of an operating system (“OS”). The special circuitry and software operate without regard to the existence or type of OS present on the managed server 2. Therefore, the present technique may be useful for accessing, interacting, and/or monitoring the managed server 2 from the remote console 5 even before its OS has been loaded. More specifically, the video displayed on monitor 4 is capable of being viewed on a monitor 8 independent of the OS.

The network N can be virtually any sort of network capable of transmitting data between two devices. Without limitation, some examples of networks include: a local area network, a wide area network, a hardwired point-to-point connection, a point-to-point connection over a telecommunications line, a wireless connection, and an Internet connection.

Although the managed server 2 shown is of an International Business Machines (IBM) PC-compatible variety, the principles of the present technique are believed to be equally applicable to other computer platforms or architectures, such as those manufactured by Compaq, Apple, Sun, and Hewlett Packard. Additionally, the managed server 2 could be one architecture and the remote console 5 could be another. For example, the managed server 2 could be a x86 architecture computer running Microsoft Windows NT OS and the remote console 5 could be a Sun workstation running Solaris OS.

In the operation of the present technique, video data is captured, analyzed, compressed, and transmitted to the remote console 5 by circuitry and software in the managed server 2 without reliance or interference with the operating system. The remote console 5 includes software for receiving and interpreting the transmitted data to reproduce on its own monitor 8 the video data displayed on the managed server monitor 4. The transmitted video data is encoded with commands to permit the remote console 5 to interpret the data stream.

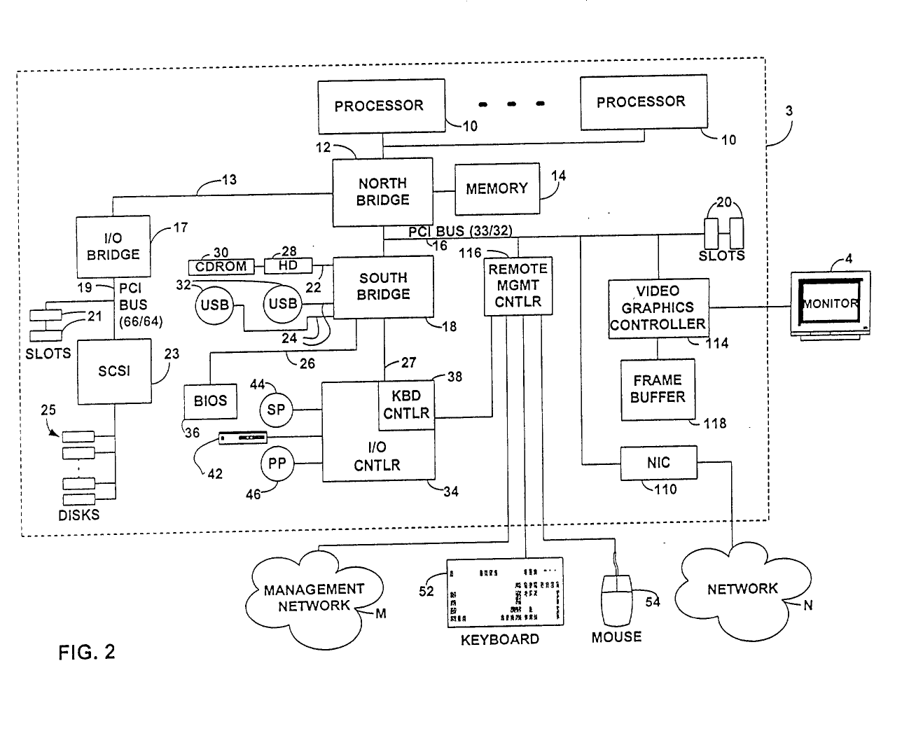

Now referring to FIG. 2, there is illustrated a block diagram of the managed server 2 according to one exemplary embodiment. To provide sufficient processing power, the managed server 2 includes one or more processors 10, such as a Pentium III processor or other processors manufactured by Intel Corporation. Each processor 10 may include a special non-maskable interrupt, called the system management interrupt (“SMI”), which causes the processor to operate in a special system management mode (“SMM”) independent of the operating system. This functionality is fully explained in literature available from Intel.

The processor 10 is coupled to a north bridge 12, such as an ServerWorks HE-SL (NB6576). The north bridge includes a memory controller for accessing a main memory 14 (e.g., synchronous dynamic random access memory (“SDRAM”)). The north bridge 12 is coupled to a south bridge 18 by a bus 16, such as a PCI bus, and is coupled to one or more I/O bridges 17 by a bus 13, such as a fast I/O bus. Thus, the north bridge 12 provides the data port and buffering for data transferred between the processor 10, memory 14, and busses 13 and 16. In the managed server 2, the north bridge 12 provides a PCI or PCI-X bus 16 that is coupled to one or more PCI or PCI-X slots 20 for receiving expansion cards. For the purposes of this discussion, the embodiment will be described using PCI technology with the understanding that PCI-X technology may be used as well.

The I/O bridge 17 may provide bridging for one or more expansion busses such as additional PCI or PCI-X buses 19, for example, that may be coupled to various peripheral devices. In this example, the PCI bus 19 is coupled to I/O slots 21 and to a SCSI controller 23 which, in turn, is coupled to a plurality of disk drives 25. It should be noted, in this exemplary embodiment, that the bus 19 is a 64-bit bus that runs at 66 MHz to provide faster data transfer as compared with the PCI bus 16, as discussed below, which is a 32-bit bus that runs as 33 MHz.

The south bridge 18 is an integrated multifunctional component, such as the ServerWorks CSB5, that may include a number of functions, such as, an enhanced direct memory access (“DMA”) controller; interrupt controller; timer; integrated drive electronics (“IDE”) controller for providing an IDE bus 22; a universal serial bus (“USB”) host controller for providing a universal serial bus 24; an system ROM interface 26; a bus controller for providing a low pin count bus (“LPC”) 27; and ACPI compliant power management logic. The IDE bus 22 typically supports up to four IDE devices, such as a hard disk drive 28 and a compact disk read only memory (“CD-ROM”) 30. The universal serial bus 24 is connected to a pair of USB connectors 32 for communicating with USB devices (not shown).

The LPC bus 27 couples the south bridge 18 to a multifunction input/output (I/O) controller 34, while the system ROM interface 26 couples to a basic input/output system (BIOS) ROM 36. The multifunction I/O controller 34, such as a National Semiconductor PC87417, typically includes a number of functions, such as a floppy disk drive controller for connecting to a floppy disk drive 42; a keyboard controller 38 for connecting to a keyboard and a pointing device; a serial communications controller for providing at least one serial port 44; and a parallel port interface for providing at least one parallel port 46. Alternative multifunction input/output (I/O) controllers are manufactured by Standard Microsystems Corporation and WinBond, for example.

Further attached to the PCI bus 16 is a remote management controller 116. The remote management controller 116 connects to the keyboard controller 38, the network N and/or a management network M, a keyboard 52, and a mouse 54 to provide functionality for accessing, interacting, and monitoring the managed server 2 from the remote console 5 as will be more fully described below.

Prior to continuing this discussion, it should be understood that the functions described herein may alternatively be implemented in separate integrated circuits or combined differently than described above without departing from the concept of the present technique.

Further attached to the PCI bus 16 is a video graphics controller 114 and one or more communications devices, such as a network interface controller (“NIC”) 110. Other communications devices, such as modems, can be used as required by the network type.

The video graphics controller 114 may be an integrated video graphics controller, such as an ATI technologies Rage IIC or XL, that supports a wide variety of memory configurations, color depths, and resolutions. Connected to the video graphics controller 114 is a frame buffer 118 (e.g., synchronous DRAM) for storing video graphics images written by the processor 10 for display on the monitor 4. The video graphics controller 114 includes 32-bit driver support for accessing the frame buffer 118 via a linear aperture mapped into PCI address space. This mechanism conveniently allows linear access to the frame buffer for all video modes, including legacy video graphics array (VGA) modes.

The remote management controller 116, as described in more detail below, includes circuitry for snooping the PCI bus for configuration transactions between the processor 10 and the video graphics controller 114 to determine configuration and mode information, such as whether the video graphics controller is in text or graphics mode. More specifically, the remote management controller 116 snoops indexed input/output (I/O) ports of the video graphics controller 114 to provide a set of shadow registers corresponding to mode information. These I/O ports are particularly helpful for legacy video graphics array (VGA) compatibility mode. In addition, the shadow registers of the remote management controller 116 provide a set of registers for the I/O processor 156 to access independently of the operating system running on processor 10, thereby preventing any conflicts that could arise if both processors were trying to access the indexed I/O ports simultaneously. The remote management controller 116 also snoops and stores configuration information sent by the processor 10 to the video graphics controller 114. This information is used to identify the location of the linear aperture as well as the location of other configurable resources in the video graphics controller 114, (e.g.,location of SVGA register file). The remote management controller 116 also includes circuitry to route keystrokes to the keyboard controller 38 from either the local keyboard 52 or from the remote console 5 via the modem or NIC 110 which may be coupled to the network M. This keyboard functionality is more fully explained in U.S. Pat. No. 5,898,861, entitled “Transparent Keyboard Hot Plug.”

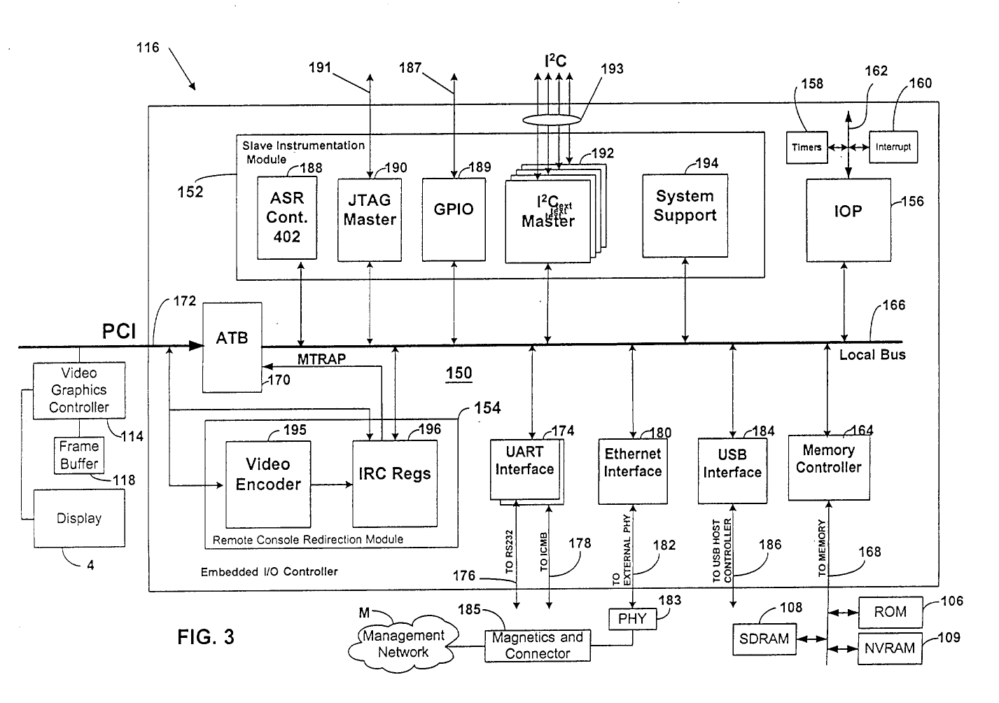

In the operation of the remote management controller 116, the I/O processor 156 (FIG. 3) may periodically read the video graphics data from the frame buffer 118 to determine whether the data has changed. If the data has changed, the I/O processor 156 will compress the video graphics data and transmit the data to the remote console 5 via one of the communications devices (i.e., modem or NIC 110). The remote console 5 will decompress and decode the data stream and display it at the remote console 5 for viewing by a user.

Remote Management Controller

FIG. 3 shows a functional block diagram of one exemplary embodiment of a remote server management controller 116 constructed according to the present invention. The remote server management controller 116 may be implemented in a single application specific integrated circuit (“ASIC”). Alternatively, the remote server management controller 116 may be implemented in a plurality of integrated circuits or discrete components. Those skilled in the art will appreciate that implementation details such as deciding which functional aspects of remote server management controller 116 are implemented in a single ASIC or different ASICs are matters of design choice and are not believed to be crucial aspects of the present invention.

For purposes of describing the invention clearly, the remainder of this description is written assuming that the remote server management controller 116 is implemented using a single ASIC for the embedded I/O controller 150, which may be incorporated into the motherboard of the managed server 2. Additionally, any client computers that may be connected directly or indirectly to the managed server 2 may establish communication with the remote server management controller 116 through its network connection as is more fully described below. Users may further interface with the remote server management controller 116 through additional communications interfaces such as a modem.

The remote server management controller 116 may be implemented so that it is powered and capable of operation whether or not the managed server 2 is powered up (turned on) or online. Powering the remote server management controller 116 regardless of whether the host managed server is turned on allows the remote server management controller 116 to monitor, analyze and potentially intervene to correct a wide range of system problems that may befall the managed server 2.

The logic of the remote server management controller 116 is broken down into three main functional blocks. The first of these three functional blocks is an embedded I/O controller 150, which is essentially an independent computer system that is integrated within the managed server 2. The second and third functional blocks of the remote server management controller 116 are a slave instrumentation module 152 and a remote console redirection module 154. As described below, the embedded I/O controller 150 monitors and controls a wide range of conditions in the managed server 20 via the slave instrumentation module 152 and the remote console redirection module 154.

The embedded I/O controller 150 includes an Input/Output processor (“IOP”) 156, which provides general control and functions as a management processor for the remote server management controller 116. The IOP 156 may be implemented as a 32-bit RISC processor, but other processor implementations may be employed as well. The IOP 156 is operatively coupled to a timer module 158 and an interrupt controller 160 via a peripheral bus 162.

In one exemplary embodiment, a memory controller 164 is operatively coupled to the internal local bus 166. The memory controller 164 is, in turn, operatively coupled to dedicated memory via a memory interface 168. The dedicated memory may include battery-backed SRAM, SDRAM, ROM, NVRAM or any other appropriate type of memory. In this embodiment, the memory interface 168 is coupled to SDRAM 108, ROM 106, and NVRAM 109.

The IOP 156 is operatively coupled to the other functional modules (and possibly many sub-modules) of the remote server management controller 116 via an internal local bus 166. Those of ordinary skill in the field will appreciate that the internal local bus 166 exists to allow communication between and among the logical components of the embedded I/O controller 150. The implementation details of the internal local bus 166 are a matter of design choice and are not believed to be a crucial aspect of the present invention.

An address translation and bridging (“ATB”) unit 170 is operatively coupled to the internal local bus 166 and to a PCI bus 172. PCI bus 172 is integral within and operatively coupled with the managed server 2. The PCI bus 172, which serves as the main communication interface between the managed server 2 and the remote server management controller 116, may be configured as a 32-bit, 33 MHz PCI master/slave interface. In a typical system implementation, the remote server management controller 116 resides on the “compatibility” segment of PCI bus 172, but the bus on which the remote server management controller 116 is disposed is not believed to be a crucial aspect of the invention. In this embodiment, the ATB unit 170 is constructed to allow the remote server management controller 116 to decode bus cycles on the PCI bus 172 and to communicate over the PCI bus 172 by initiating PCI bus cycles as explained in greater detail below.

The remote server management controller 116 may be adapted to snoop video traffic via PCI bus 172, which is merely an extension of the PCI bus 16. For example, FIG. 3 illustrates the remote server management controller 116 being coupled to the video graphics controller 114, and thus its associated frame buffer 118 and display 4, via the PCI bus 172. Additionally, the PCI bus 172 provides sufficient bandwidth to allow the remote server management controller 116 to actively procure graphical video data as well as textual video data. Although other protocols could be used for the main interconnect between remote server management controller 116 and managed server 2, PCI bus 172 is typically used instead of other slower interfaces, such as ISA or LPC, because the PCI bus 172 allows the transfer of much greater quantities of data. The remote server management controller 116 is capable of independent operation even if the PCI interface 172 is not operational because of a problem with managed server 2.

The embedded I/O controller 150 provides a plurality of communication interfaces that can be employed to establish out-of-band communication sessions with the remote server management controller 116. One such communication interface is a UART interface module 174, which is operatively coupled to internal local bus 166. The exemplary UART interface module 174 comprises two standard 16550 UARTs, each of which may provide a separate serial communication interface. Both UARTs are mapped into the address space of the IOP 156 and can be accessed via the PCI bus 172 or by the IOP 156. Either UART may be implemented so that it can be reset through a control register in the address space of the IOP 156.

Outputs from the UART interface module 174 are typically routed to transceivers (not shown), where they may be converted into a wide variety of serial interface types. Examples of the types of serial interfaces that may be provided by the UART interface module 174 are a standard RS-232 interface 176 or an interface that complies with the Intelligent Chassis Management Bus (“ICMB”) specification promulgated by Intel Corporation (ICMB interface 178). Those of ordinary skill in the field will appreciate that the RS-232 interface 176 may be used to connect to a wide range of industry standard modems, terminal servers, and the like. In one exemplary embodiment, the RS-232 interface 176 and/or the ICMB interface 178 are accessible to a user from the external chassis of the managed server 2. A user may, accordingly, use an external communication device to engage in an out-of-band communication session with the remote server management controller 116 via the UART interface 176 or the ICMB interface 178.

The embedded I/O controller 150 may also include an Ethernet interface 180, which is operatively coupled to the internal local bus 166. The Ethernet interface 180 provides the main external communication interface between the remote server management controller 116 and the outside world. In the exemplary embodiment shown in FIG. 3, the integrated portion of the Ethernet interface 180 includes a MAC (Media Access Controller), inbound and outbound FIFOs and a DMA engine to transfer packets automatically to and from memory. The Ethernet interface 180 utilizes a connection via interface 182 to an external PHY 183 and typical magnetics and connectors 185 to couple the PHY 183 to the wire that serves as the transmission media. For example, this connection is typically used to couple the remote management controller 116 to the management network M.

Those skilled in the art will appreciate that a user may connect remotely to the remote server management controller 116 via the Ethernet interface 180. Such a connection may be made, for example, using a remote console application running on a client computer anywhere on the network that includes managed server 2. The user may, thus, engage in out-of-band communication with the remote server management controller 116 for the purpose of diagnosing, correcting and/or preventing problems with the managed server 2.

The embedded I/O controller 150 may further include a USB interface 184, which is operatively coupled to the internal local bus 166. The USB interface 184 is connected to a USB host controller (not shown) via a USB host controller interface 186. In one exemplary embodiment, the USB interface 184 is connected to one port of a USB host controller (USB bus 24 of FIG. 2), which is typically located in a south bridge 18 portion of the chipset of the managed server 2. When implemented in this way, the IOP 156 of the remote server management controller 116 may establish “virtual USB peripherals” that will be seen and recognized by any USB-aware OS. These virtual peripherals may be presented to any OS to allow communication with the OS in a common, OS-independent manner.

USB keyboards, USB mice, USB floppy drives, USB CD drives and USB 10base-T Ethernet controllers are just a few examples of the wide range of USB devices that could be emulated by the IOP 156 via the USB interface 184. The ability to emulate USB keyboards and mice allow the remote server management controller 116 to create a “legacy free” system environment. As the eventual removal of the traditional 8042-style keyboard controller from computer system architecture becomes a reality, the ability of prior art remote server management tools to provide traditional remote keyboard functionality will become irrelevant. The USB device emulation provided by USB interface 184 provides a way to deliver keystrokes and mouse status updates to the OS in a system without an 8042 keyboard controller.

USB storage devices (such as floppy drives and CD drives) provide additional capability from a remote management point of view because the USB interface 184 allows the remote server management controller 116 to act as a host for hot-pluggable storage devices. This capability allows remote server management controller 116 to mount additional storage volumes to the managed server 2 in an OS-independent fashion. Ideally, the USB storage volumes would reside on an application such as a remote management console, giving the administrator remote CD drive and/or floppy drive functionality. Other emulated devices, such as a standard Ethernet controller, are interesting because the USB interface gives the remote management controller 116 a well-defined, hot-plug interface for communication which does not require a specific proprietary device driver. Those of skill in the field will appreciate that USB emulated devices are supported by the system BIOS 36 of the managed server 2 prior to when the OS is booted. If the OS of the managed server 2 is USB-aware, then it takes up support of the USB devices after boot.

The second major functional block of the remote server management controller 116 is the slave instrumentation module 152. The primary purpose of the slave instrumentation module 152 is to provide the hardware infrastructure to implement control and monitoring functions in the managed server 2 as dictated by the IOP 156 in conjunction with dedicated application software such as remote console management software running on a client computer.

The slave instrumentation module 152 comprises an automatic server recovery (“ASR”) controller 188, which operates to respond automatically to catastrophic failures of the managed server 2. The ASR-controller 188 is operatively coupled to the internal local bus 166. The ASR controller 188 continually monitors whether the OS of the managed server 2 is operational by controlling a dead-man timer that is periodically serviced by the OS. If the OS of the managed server 2 does not service the dead-man timer within a predetermined time, the ASR controller 188 resets the processor of the managed server 2 causing the managed server 2 to reboot.

A general purpose input/output module (“GPIO”) 189 is provided in the exemplary embodiment of the slave instrumentation module 152. The GPIO provides a versatile communication interface that may be used for a wide variety of purposes.

The slave instrumentation module 152 also comprises a JTAG master 190. The JTAG master 190 is operatively coupled to the internal local bus 166. The JTAG master 190 comprises a standard JTAG interface 191, which is operatively coupled to a corresponding standard JTAG interface (not shown) on the motherboard of the managed server 2. Through the JTAG master 190, the remote server management controller 116 can perform a wide range of control functions on the managed server 2. These functions include updating or repairing the BIOS 36 of the managed server 2 by reprogramming the non-volatile memory where the BIOS resides.

The slave instrumentation module 152 further comprises an I²C master 192, which is operatively coupled with the internal local bus 166. The 1²C master 192 has the capability of controlling a plurality of independent I²C serial channels 193. For purposes of example only, four (4) separate I²C channels are shown in FIG. 2. The I²C master 192 comprises a separate I²C engine for controlling each separate I²C channel.

The slave instrumentation module 152 additionally comprises a block of system support logic 194. The system support logic 194 is operatively coupled to the internal local bus 166. The system support logic 194 provides a variety of housekeeping and security functions for the managed server 2. Examples of these functions include providing the EISA bus ID, flash ROM support, ECC support, hot spare boot support, system post monitor support, floppy write protect, SMI base security measures, open hood detection and the like.

The third major functional block of the remote server management controller 116 is the remote console redirection module 154, which comprises a video encoder 195 and integrated remote console (“IRC”) registers 196. The IRC registers 196 receive raw data snooped from the PCI bus 172. Under control of the IOP 156, some of the IRC registers 154 may function as a virtual communication device (“VCD”) that may be used to intercept UART communications or communications from other sources. Data intercepted through the VCD may be altered by the IOP and/or redirected to other outputs of the remote server management controller 116. For example, data intercepted by the VCD may be redirected to a remote user via the Ethernet interface 180.

The VCD functionality may be used to present a virtual modem to the managed server, allowing it to be either exclusively owned or shared both by the OS and a remote console application. This technique is fully described in U.S. Pat. No. 5,790,895, which is incorporated by reference above.

In one exemplary embodiment of the remote server management controller of the present invention, the VCD presents a virtual 16550 UART to the internal architecture of managed server 2. The VCD logic enables the remote server management controller 116 to communicate with specific OS features, such as the Emergency Management Services (“EMS”) facility that is implemented in Windows XP.

Security Manager

The managed server 2 advantageously includes a security manager that includes a security sign-on system that may be stored and operated on the remote management controller 116 to provide for “lights out” management. In the exemplary embodiment, the security sign-on system includes authentication of services to prove the identity of each user, a directory service to provide each user with entry into each appropriate function or resource, and a service, that may include an encryption and certification component which verifies the user to the directory service. In regard to the latter, the managed server 2 may include a public key infrastructure (PKI) to ensure that the appropriate users are utilizing the resources identified by the directory services. In regard to the certificate services, when a user establishes identity with a certificate authority via the authentication services, the managed server 2 generates a unique signature key and encryption key pairs in the form of certificates that include the user ID, and the certificates contain the certificate authority's private key to establish authenticity. In regard to the authentication services, they may take one or more forms including user ID/password pairs, challenge/response tokens, biometrics, or other methods of ensuring a positive identification. For example, hardware-based challenge/response mechanisms, such as smartcards, use devices to generate unique one-time pass codes. When the devices are issued, they are associated with an ID that triggers a password request to provide accurate authentication. Biometrics may offer even more accurate identification through the use of encoded versions of unique personal features, such as voice, retinal image, facial image, or fingerprints.

In regard to the types of functions or resources available through the managed server 2, it should be understood that these functions or resources (also referred to as features or privileges) can be numerous and widely varied. Indeed, certain functions are quite critical to the overall operation of the managed server 2 and/or network N, while other functions are only moderately critical or relatively non-critical. It should further be understood that not all users are typically granted access to every resource. Indeed, a typical user may be granted access to only certain non-critical resources, while, at the other end of the spectrum, only network administrators may be granted access to every resource.

In the present embodiment, each user may be assigned at least one individual privilege set of features or functions offered by the system. Furthermore, depending upon various parameters, such as the IP address, connection type, time of day, current client list of the company, work day versus weekend day, the type of authentication required to log on to the system and/or the user's feature set may change. In other words, each privilege may be controlled by its own expression in either the server's security profile or the user's individual profile.

In an effort to provide examples to illustrate the manner in which different users or different groups of users may be affected by this type of system, certain types of functions available through the managed server 2 may be divided into various categories, such as critical functions, moderately critical functions, and non-critical functions for example, as set forth in Table 1 below. However, while the grouping of functions into various categories and the assignment of various users into user groups may be accomplished in the system, it should be understood that these groups are presented by way of example. Indeed, each user may have one or more individual sets of features and/or authentication requirements. These individual feature sets and/or authentication requirements may or may not fall within a group in an actual implementation. It should be further understood that critical functions in one enterprise may be only moderately critical or non-critical in another enterprise.

In the present example, critical functions may include those functions that could cause harm to the system and/or business. Such critical functions may include, for example, booting the server, powering down the server, flashing the ROM or firmware of the server, erasing event or security logs, or altering the firewall (not shown) of the system. It can certainly be appreciated that such critical functions may have deleterious or even disastrous effects on the managed server 2, and possibly on the network N as well, if such functions are not performed competently and properly. Moderately critical functions may include those functions that would typically not have such deleterious or disastrous effects, but those which might affect a user's access to the system or the resources available on the system. Such moderately critical functions may include, for example, altering user profiles, suppressing backups, performing backups, altering device mapping, updating programs, pushing or pulling programs, remote management of client computers, altering IP addresses, etc. Finally, non-critical functions may include, for example, file and device sharing, initiation of virus scans, access to virtual media, alteration of directories, etc.

TABLE 1
Types of Functions

| | Moderately | |
|---|---|---|
| Critical Functions | Critical Functions | Non-Critical Functions |
| boot server | alter user profiles | file/device sharing |
| power down server | suppress backup | initiate virus scans |
| flash ROM/firmware | perform backup | virtual media |
| erase event/security logs | alter drive mapping | alter directories |
| alter firewall | update programs | |
| | push or pull programs | |
| | remote management of | |
| | client computers | |
| | alter IP addresses | |

In a conventional system, each user is properly authenticated. This authentication process grants the user certain privileges or access to a given feature set of the system. In such a conventional system, it does not matter whether the user is logging on to the managed server directly, through an in-house terminal coupled to the managed server, or through a terminal located outside of the business facilities. In any of these cases, the identification of the user is typically authenticated in the same manner and, once authenticated, the user is granted the same privileges.

In the interest of improved security, it can be appreciated that such a conventional system may possess certain drawbacks. For example, if the managed server 2 is located in a secure facility, only network administrators and their administrative assistants, and not typical users, would have direct access to the managed server 2. Because of this physical security, there is a high probability that only authorized users will attempt to log on to the managed server 2 directly, at least during normal business hours. Accordingly, in such a situation, the authentication services provided by the managed server 2 may be less rigorous in order to simplify and hasten the login process by the network administrators and their administrative assistants. This authentication process may be applied to control whether strong client side authentication is utilized for a user based on an expression using supported parameters such as IP address, connection type, time of day, etc.

Of course, the further the access point is removed from a direct connection in the secure physical location of the managed server 2, the higher the probability that an unauthorized user may attempt to access the managed server 2. For example, if a network administrator attempts to access the managed server 2 through a remote management PC 5 located in the business facility, albeit outside of the secure facility in which the managed server 2 is housed, there is still a reasonable degree of certainty that an imposter is not attempting to log on to the managed server 2, at least during normal business hours. However, because entry into the regular business facility may not be as restricted or guarded as entry into the facility in which the managed server 2 is housed, the managed server 2 may require a more rigorous authentication of the user's identification. In fact, in certain circumstances, such as if a network administrator was logging on to the managed server 2 from a remote location outside of the business facility, privileges may be restricted even if authentication of the user's identification is fairly rigorous.

Various examples of such a flexible security system are described below with reference to Tables 2-4. As set forth below, these tables list certain authentication requirements, security settings, and privileges that may be available to certain users or groups of users depending upon certain criteria, such as IP address, connection type, time of day, etc. As shown in these examples, the more remote the connection, the more rigorous the authentication that may be required. Likewise, connections made during normal working hours may require less rigorous authentication that connections made during non-business hours. Also, similarly, the range of a particular user's privileges may be restricted depending upon the type and time of connection. In other words, a particular user or group of users may have a first feature set if accessing the managed server 2 from a relatively secure location during normal business hours, while the particular user or group of users may have other feature sets if accessing the managed server 2 from other locations and/or at other times.

Looking first to the example set forth in Table 2, in particular, a network administrator (Net-admin1) or a group of network administrators (group:admin1) may be allowed to use a simple password for authentication if directly accessing the managed server 2 during normal business hours, but the authentication technique may become more rigorous, requiring the use of a smartcard or biometrics for instance, if the network administrator attempts to log on to the managed server 2 from a remote in-house or outside terminal, or even if the network administrator attempts to log on directly during off hours. Furthermore, any type of remote access would typically utilize encryption techniques, while direct access may not. Finally, if there is a relatively high level of confidence that the identity of the network administrator has been properly authenticated, such as in situations 1, 2, and 4, the network administrator may be granted full privileges, i.e., a first feature set. However, if there is less confidence in the authentication of the network administrator's identity, or if certain critical functions should not be performed due to the time of day or remoteness of the network administrator, certain privileges may be restricted, such as in situations 3, 5, and 6, where situations 3 and 5 may exemplify a second feature set and situation 6 may exemplify a third feature set.

TABLE 2
Network Administrator

| | IP Address/ | Time | | Security | |
|---|---|---|---|---|---|
| User ID | Connector Type | of Day | Authentication | Settings | Privileges |
| 1 Net-admin 1 | Direct | 8 am-5 pm | Password | No encryption | Full |
| (group:admin 1) | | | | | |
| 2 Net-admin 1 | In-house | 8 am-5 pm | Smartcard | Encryption | Full |
| (group:admin 1) | | | | | |
| 3 Net-admin 1 | Remote | 8 am-5 pm | Biometric | Encryption | Moderate and |
| (group:admin 1) | | | | | non-critical only |
| 4 Net-admin 1 | Direct | 5 pm-8 am | Biometric | No encryption | Full |
| (group:admin 1) | | | | | |
| 5 Net-admin 1 | In-house | 5 pm-8 am | Biometric | Encryption | Moderate and |
| (group:admin 1) | | | | | non-critical only |
| 6 Net-admin 1 | Remote | 5 pm-8 am | Biometric | Encryption | Non-critical only |
| (group:admin 1) | | | | | |

A typical administrative assistant (Admin-asst 1) to the network administrator, or a group of administrative assistants (group:admin2), may have a profile as set forth in Table 3. The administrative assistant may be given full privileges when directly accessing the managed server 2 during normal business hours, but the authentication requirements may increase and the privileges may become more restricted during off hours or as the connection becomes more remote.

TALE 3
Administrative Assistant

| | IP Address/ | Time | | Security | |
|---|---|---|---|---|---|
| User ID | Connector Type | of Day | Authentication | Settings | Privileges |
| 1 Admin-asst 1 | Direct | 8 am-5 pm | Password | No encryption | Full |
| (group:admin 2) | | | | | |
| 2 Admin-asst 1 | In-house | 8 am-5 pm | Smartoard | Encryption | Moderate and |
| (group:admin 2) | | | | | non-critical only |
| 3 Admin-asst 1 | Remote | 8 am-5 pm | Biometric | Encryption | Non-critical only |
| (group:admin 2) | | | | | |
| 4 Admin-asst 1 | Direct 5 pm-8 am | Biometric | No encryption | Moderate and | |
| (group:admin 2) | | | | | non-critical only |
| 5 Admin-asst 1 | In-house | 5 pm-8 am | Biometric | Encryption | Non-critical only |
| (group:admin 2) | | | | | |
| 6 Admin-asst 1 | Remote | 5 pm-8 am | Biometric | Encryption | Non-critical only |
| (group:adinin 2) | | | | | |

A typical user (Joe-user) or a typical group of users (group:user 1) may have a profile as set forth in Table 4. As set forth in situations 1 and 4, a typical user may not be permitted direct access to the managed server 2, either through denial of entry into the physical facility in which the managed server 2 is located, and/or through denial of the managed server 2 from authenticating the user or granting the user any privileges if a direct connection is attempted. Furthermore, the typical user may not normally be granted access to critical or moderately critical functions as defined by the enterprise. In this example, the user is granted access to non-critical functions in situations 2, 3, 5, and 7. In situation 2, for example, if the user logs on to the managed server 2 through an in-house terminal during normal business hours, authentication may not be to rigorous, requiring only a password for instance. This relatively low level of authentication may be warranted because it provides the user quick access at relatively low cost. Furthermore, there is a reasonable expectation that unauthorized users would not have access to the user's terminal during normal work hours, and even if access was granted to an unauthorized user, the unauthorized user would only have access to functions specified as non-critical by the enterprise.

Of course, as the confidence level in the actual identity of the authorized user falls, such as in remote and/or off hour connections depicted in situations 3 and 5, the authentication services may become more rigorous and require the use of a smartcard or biometrics, for example. Once the user is properly authenticated, access to non-critical functions is granted. Finally, a user, such as the typical user depicted in Table 4, may attempt different types of remote connections, such as via the Internet or via a virtual private network. It may be determined that all users, or at least certain groups of users, should not be granted access to the managed server 2 via an Internet connection as set forth in situation 6. However, all users, or certain groups of users, may be permitted access during normal and/or off business hours via a virtual private network with proper authentication, as set forth in situation 7.

TABLE 4
User

| | IP Address/ | Time | | Security | |
|---|---|---|---|---|---|
| User ID | Connector Type | of Day | Authentication | Settings | Privileges |
| 1 Joe-user | Direct | 8 am-5 pm | NA | NA | None |
| (group:user 1) | | | | | |
| 2 Joe-user | In-house | 8 am-5 pm | Password | Encryption | Non-critical |
| (group:user 1) | | | | | |
| 3 Joe-user | Remote | 8 am-5 pm | Smartcard/ | Encryption | Non-critical |
| (group:user 1) | | | Biometric | | |
| 4 Joe-user | Direct | 5 pm-8 am | NA | NA | None |
| (group:user 1) | | | | | |
| 5 Joe-user | In-house | 5 pm-8 am | Smartcard/ | Encryption | Non-critical |
| (group:user 1) | | | Biometric | | |
| 6 Joe-user | Remote | 5 pm-8 am | NA | NA | None |
| (group:user 1) | (Internet) | | | | |
| 7 Joe-user | Remote | 5 pm-8 am | Smartcard/ | Encryption | Non-critical |
| (group:user 1) | (VPN) | | Biometric | | |

It should be appreciated that the information and profiles set fort h in Tables 1-4 are merely provided by way of example, since the organization of functions, the assignment of privileges, the determination of authentication, and the selection of criteria and restrictions may vary widely and will, in most cases, be dictated by commercial and business considerations, including the type of network, the size of network, cost, availability, convenience, expertise, etc. Furthermore, while the examples have been described in tabular or matrix form, it should be understood that those skilled in the art will recognize that these profiles may be implemented in a variety of ways. For example, these variables could be factored into one or more equations or decisions that can be evaluated, e.g., Grant-access-if (Time>8:00 am and Time<5:00 pm) or (IP Address=12.34.56.78).

The privileges or attributes afforded to each user may be assigned in a variety of ways. For example, a security setting screen may be provided to permit an authorized user, such as a network administrator, to set the attributes for each user. Using the security setting screen, the network administrator may select certain features that a given user may access using simple yes/no toggles. The network administrator may also select various IP addresses or address ranges, blocks of time, authentication requirements, etc., to build the feature sets for the user.

While the discussion above only refers to authenticating a user at the time the user logs on to the system, the privileges and/or authentication of a user may be determined each time a request is made. For example, each time an operation is attempted, the system's firmware may place a call to the security manager to determine whether the user has sufficient privileges to perform the operation. If a user is requesting virtual media usage, for instance, before the USB interface presents information about the virtual media device, it may place a call to the security manager to make sure the user has privileges to use the virtual media. Then, on a block-by-block basis, as the connection uses the virtual media, it may verify that the user still has the appropriate privilege level. In other words, the security manager may continue to monitor the user's privileges, so the calling modules do not have to perform these functions. It should be understood that just because a previous call to the security manager returned a status message that permitted the requested operation, that does not mean that all subsequent calls will since the privilege level of the user may be variable based on time of day or day of the week, for instance.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of providing security in a computer system, the method comprising the acts of:
determining one of a plurality of different authentication levels for a user in response to at least one of connection type and time of connection; and
assigning one of a plurality of privilege sets to the user in response to at least one of connection type and time of connection.

2. The method, as set forth in claim 1, wherein the more remote the connection type, the higher the authentication level.

3. The method, as set forth in claim 1, wherein the plurality of different authentication levels comprise a first authentication level and a second authentication level, the first authentication level being lower than the second authentication level.

4. The method, as set forth in claim 3, wherein the connection type comprises a direct connection, and wherein the authentication level comprises the first authentication level.

5. The method, as set forth in claim 3, wherein the connection type comprises an in-house remote connection, and wherein the authentication level comprises the second authentication level.

6. The method, as set forth in claim 3, wherein the connection type comprises an outside remote connection, and wherein the authentication level comprises the second authentication level.

7. The method, as set forth in claim 3, wherein the time of connection comprises during business hours, and wherein the authentication level comprises the first authentication level.

8. The method, as set forth in claim 3, wherein the time of connection comprises during non-business hours, and wherein the authentication level comprises the second authentication level.

9. The method, as set forth in claim 3, wherein the first authentication level comprises a password, and wherein the second authentication level comprises a smartcard.

10. The method, as set forth in claim 3, wherein the first authentication level comprises a password, and wherein the second authentication level comprises biometrics.

11. The method, as set forth in claim 3, wherein the first authentication level comprises a smartcard, and wherein the second authentication level comprises biometrics.

12. The method, as set forth in claim 1, wherein the more remote the connection type, the more restricted the privilege set.

13. The method, as set forth in claim 1, wherein the plurality of different privilege sets comprise a first privilege set and a second privilege set, the first privilege set comprising full privileges for the user and the second privilege set comprising restricted privileges for the user.

14. The method, as set forth in claim 13, wherein the connection type comprises a direct connection, and wherein the privilege set comprises the first privilege set.

15. The method, as set forth in claim 13, wherein the connection type comprises an in-house remote connection, and wherein the privilege set comprises the first privilege set.

16. The method, as set forth in claim 13, wherein the connection type comprises an outside remote connection, and wherein the privilege set comprises the second privilege set.

17. The method, as set forth in claim 13, wherein the time of connection comprises during business hours, and wherein the privilege set comprises the first privilege set.

18. The method, as set forth in claim 13, wherein the time of connection comprises during non-business hours, and wherein the privilege set comprises the second privilege set.

19. The method, as set forth in claim 14, wherein the plurality of different authentication levels comprise a first authentication level and a second authentication level, the first authentication level being lower than the second authentication level, the authentication level comprising the first authentication level for the direct connection.

20. The method, as set forth in claim 15, wherein the plurality of different authentication levels comprise a first authentication level and a second authentication level, the first authentication level being lower than the second authentication level, the authentication level comprising the second authentication level for the in-house remote connection.

21. The method, as set forth in claim 16, wherein the plurality of different authentication levels comprise a first authentication level and a second authentication level, the first authentication level being lower than the second authentication level, the authentication level comprising the second authentication level for the outside remote connection.

22. The method, as set forth in claim 17, wherein the plurality of different authentication levels comprise a first authentication level and a second authentication level, the first authentication level being lower than the second authentication level, the authentication level comprising the first authentication level for the time of connection being during business hours.

23. The method, as set forth in claim 18, wherein the plurality of different authentication levels comprise a first authentication level and a second authentication level, the first authentication level being lower than the second authentication level, the authentication level comprising the second authentication level for the time of connection being during non-business hours.
